(19) United States
(12) Patent Application Publication
(10) Pub. No.: US 2006/0274537 A1
(43) Pub. Date: Dec. 7, 2006

(54) Lamp assembly with a rotatably adjustable photocell adapter

(75) Inventor: Larry G. Randazzo, Brea, CA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hubbell Incorporated

(21) Appl. No.: 11/143,955

(22) Filed: Jun. 3, 2005

(51) Int. Cl. F21S 8/08

(52) U.S. Cl. 362/413

(57) ABSTRACT

A lamp assembly includes a support having a mounting section, a housing having a first end and a second end, and a light fixture having a base. The light fixture is adapted to receive an electrical lamp. A locking mechanism is arranged on the housing to lock the housing in a fixed position relative to the support mounting section and the light fixture. A light detection control unit is located on the housing and controls electrical power to the electrical lamp based on ambient light conditions. The first end of the housing is engageable with the light fixture. The second end of the housing is slidably engageable with the support mounting section. Thus, the housing is rotatably positionable with respect to the support mounting section and the light fixture.

### FIELD OF THE INVENTION

The present invention relates to an adapter for a lamp assembly. More particularly, the present invention relates to a rotatably positionable adapter for a lamp assembly having a light detection control unit to measure ambient light conditions, and activate a lamp as desired, the adapter allowing the light detection control unit to be aimed in the desired direction.

### BACKGROUND OF THE INVENTION

Lamp assemblies incorporating light detection switches to control the electrical power to electric lamps depending upon ambient light have been available for many years. These lamp assemblies are typically used to turn the lamps on as ambient light reduces in intensity. However, these prior art devices are not entirely acceptable for a variety of reasons.

For example, U.S. Pat. No. 3,163,768 to Bernheim discloses an adapter having a photoelectric switch for a lamp fixture. The adapter requires threads on opposite ends to threadedly connect to a lamp fixture and a support. Consequently, the adapter is expensive to manufacture and is limited to use with supports and lamps which have threads. Moreover, the photoelectric switch is located inside a closed housing with relatively limited access. Therefore, maintenance or replacement of the switch is difficult.

Another prior art photoelectric control device is disclosed in U.S. Pat. No. 3,408,501 to Thompson. This photoelectric control device has a rotatable housing adjustable relative to a photocell. The photocell is fixed relative to the housing. Rotation of the housing is limited by the length of two guide slots that prevent angular positioning beyond an angle roughly equal to 180°. Consequently, the device has a relatively limited range. Moreover, the device is comparatively complex and utilizes a multitude of moving parts. Therefore, interchangeability of the device with multiple light fixtures is relatively limited. Lastly, the device is not configured to mount to a support such as a conventional pole.

Accordingly, in order to address these disadvantages, there have been various additional attempts to provide light detection switch assemblies to control electrical lamps. Examples of light detection switch assemblies for electrical lamps are disclosed in U.S. Pat. Nos. 4,023,035 to Rodriguez; U.S. Pat. No. 5,434,764 to Lee et al.; U.S. Pat. No. 5,442,532 to Boulos et al.; U.S. Pat. No. 5,590,953 to Haslam; U.S. Pat. No. 5,626,417 to McCavit; U.S. Pat. No. 6,642,659 to Hsieh; U.S. Pat. No. 6,802,630 to Doppelt; and U.S. Patent Application Publication 2004/0223331 to Kao, each of which is hereby incorporated herein by reference in its entirety. Although some of the adjustable features of those light detection switch assemblies ease the disadvantages described above, a continuing need exists for an improved adapter for a lamp assembly which is maneuverable through 360°, inexpensive to manufacture and maintain, and relatively simple to install, and which simultaneously reduces the number of moving parts necessary for manufacture and assembly.

### SUMMARY OF THE INVENTION

An object of the present invention is to solve at least the above problems and/or disadvantages and to provide at least the advantages described below.

Accordingly, an object of the present invention is to provide an adapter for a lamp assembly which is relatively simple to install between a support mounting section and a light fixture having an electrical lamp.

Another object of the present invention is to provide a rotatably positionable adapter having a recessed light detection control unit which is relatively easy to maneuver in a desired direction through 360° to more accurately measure ambient light conditions.

A further object of the present invention is to provide an adapter that is relatively simple and inexpensive to manufacture, assemble, package and use and maintain and has a minimum number of parts.

The foregoing objects are attained by providing a lamp assembly comprising a support including a mounting section; a housing with a first end, a second end, and an aperture; a light fixture having a base and adapted to receive an electrical lamp therein; a locking mechanism arranged on the housing to lock the housing in a fixed position relative to the support mounting section and the light fixture; a light detection control unit located on the housing, the light detection control unit adapted to control the electrical lamp based on ambient light conditions, and the first end of the housing being engageable with the light fixture, and the second end of the housing being slidably engageable with the support mounting section so that the housing is rotatably positionable with respect to the support mounting section and the light fixture.

The foregoing objects are also attained by providing a lamp assembly comprising a support including a mounting section; a housing with a first end, a second end, and an aperture; a light fixture having a base and adapted to receive an electrical lamp therein, a light detection control unit located on the housing, the light detection control unit adapted to measure ambient light conditions through the aperture to control the electrical lamp and the first end of the housing having a slidably engageable outer support surface to mate with the light fixture, and the second end having a slidably engageable recess to mate with the support mounting section so that the housing is rotatably positionable with respect to the support mounting section and the light fixture.

The foregoing objects are further attained by providing an adapter for a lamp assembly having a light fixture adapted to receive an electrical lamp therein and being mounted to a support with a mounting section, comprising a housing having a first end, a second end, and an aperture a locking mechanism arranged on the housing to lock the housing in a fixed position relative to the support mounting section and the light fixture; a light detection control unit provided on the housing and adapted to measure ambient light conditions through the aperture to control the electrical lamp; and the first end of the housing having an outer support surface slidably engageable with the light fixture, and the second end of the housing slidably enageable with the support mounting section so that the housing is rotatably positionable with respect to the support mounting section and the light fixture.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will become more apparent from the following description taken in conjunction with the accompanying drawings, which form a part of this application and in which:

FIG. 1 is a perspective view of a lamp assembly in accordance with an embodiment of the present invention;

FIG. 2 is an exploded perspective view of the lamp assembly shown in FIG. 1;

FIG. 3 is a front elevational view in longitudinal cross-section of the lamp assembly shown in FIGS. 1-2; and

FIG. 4 is an enlarged perspective view in longitudinal cross section of the adapter of the lamp assembly shown in FIGS. 1-3;

Throughout the drawings, the same drawing reference numerals will be understood to refer to the same elements, features, and structures.

### DETAILED DESCRIPTION OF EXEMPLARY EMBODIMENTS

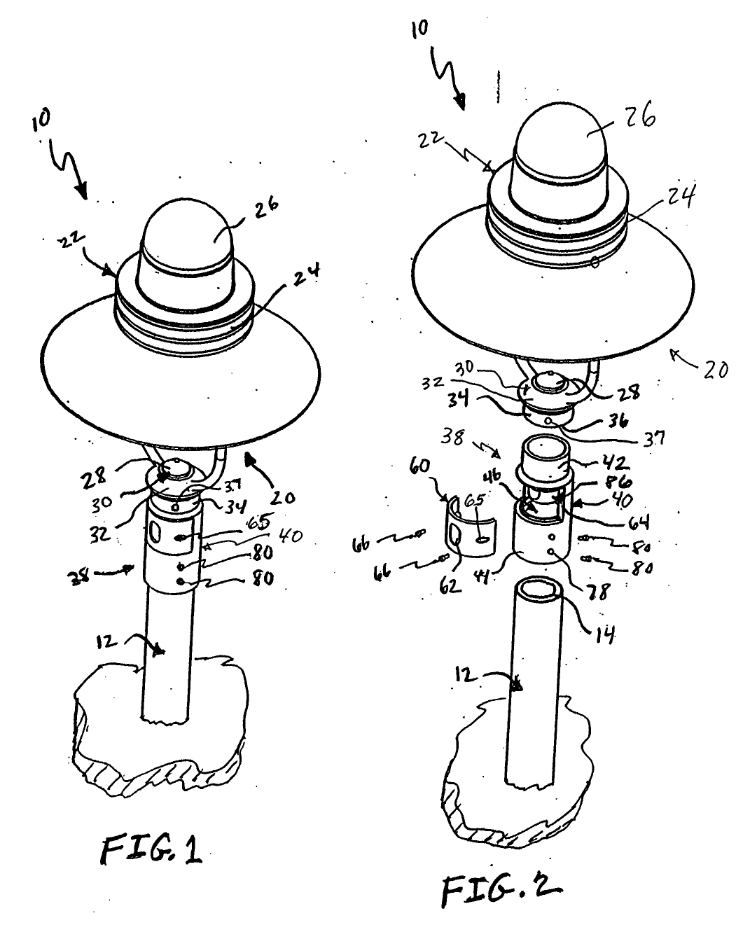

Referring to FIGS. 1-4, a lamp assembly 10 in accordance with an embodiment of the present invention is shown. The lamp assembly 10 includes a light fixture 20, an adapter 38, a light detection control unit 86, and a support 12.

As best seen in FIGS. 1-2, a conventional light fixture 20 includes an upper housing 22 having a reflector compartment 24 and a top 26. The reflector compartment 24 includes a reflector panel (not shown) to maximize light distribution. An electrical lamp 28 is provided in the lamp compartment 30. The top 26 is preferably removable to access the lamp compartment 30 to change the electrical lamp 28. Accordingly, the enclosed lamp compartment 30 is easily accessible.

A ballast compartment 32 is provided below the lamp compartment 30 and has a mounting plate (not shown). Electrical components (e.g. a lamp socket) are mounted and wired to the mounting plate for powering the electrical lamp 28.

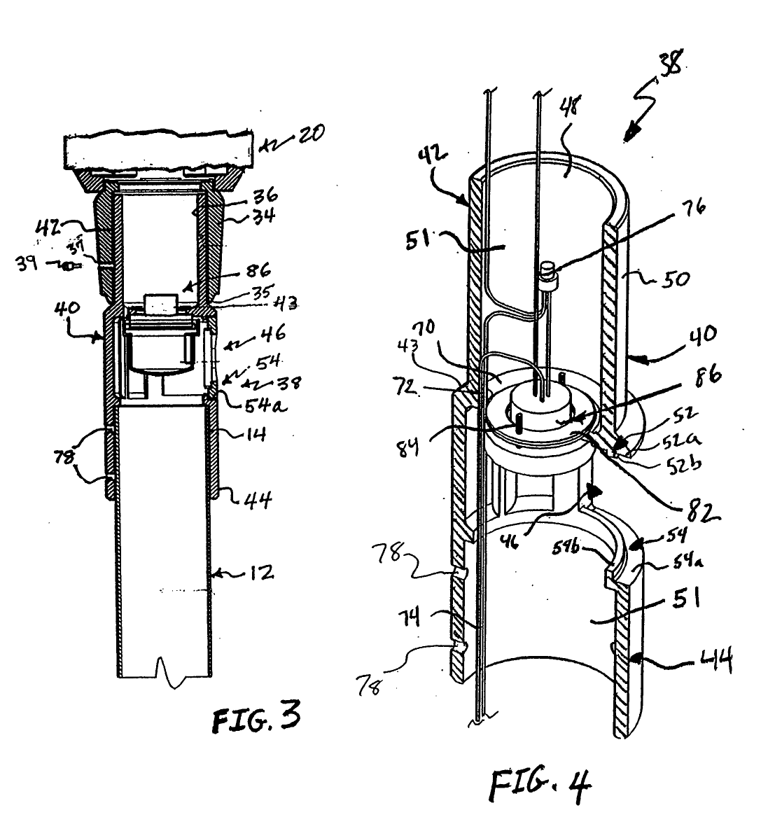

Below the ballast compartment 32 is a base 34. The base 34 slidably engages the first end 42 of the adapter housing 40 as seen in FIG. 3 and is held vertically in place when the bottom annular edge 35 of the base 34 engages an annular rim 43 on the first end 42 of the adapter housing 40. Base 34 may include an internally threaded aperture 37 to receive an externally threaded fastener 39, such as a set screw. The fastener 39 releasably secures the base 34 to the first end 42. Preferably, the base 34 is substantially annular, and advantageously substantially cylindrical in shape, and has an annular and advantageously substantially cylindrical recess 36. As best seen in FIG. 3, it is preferable that the recess 36 is of suitable size to slidably and rotatably receive the first end 42 of the adapter housing 40. It should be understood that other suitable arrangements and constructions may be used, such as having the base 34 sized for slidable and rotatable insertion into the first end 42 of the adapter housing 40.

It is also preferable that the components of the light fixture 20 are constructed of cast aluminum and the electrical lamp 28 is preferably one-piece molded clear acrylic with a lightly diffused finish. The top 26 is preferably hinged and secured with a fastener to facilitate relamping. Lastly, the reflector panel is preferably finished anodized aluminum.

As best seen in FIGS. 3-4, the adapter 38 has a housing 40 having a first end 42, a second end 44, and an aperture 46. The housing has inner and outer surfaces 48 and 50 defining a through passageway 51 therein. A middle section of the housing has the aperture 46 therein. The aperture 46 is preferably substantially rectangular in shape and extends through the housing inner and outer surfaces 48 and 50.

Flanges 52 and 54 are located on the top and bottom of the aperture 46. It is preferable that the flanges are substantially L-shaped. A first section 52a of the top flange 52 extends outwardly in a direction away from the housing outer surface 50. A second section 52b of the top flange 52 extends downwardly from and perpendicular to the top flange first section 52a. Additionally, the second section 52b extends generally parallel to the housing outer surface 50. The second section 52b of the top flange 52 may have an indicator marking or notch disposed thereon. A user may employ the indicator marking to align the housing with a certain direction (e.g. north, south, east, and west).

Also, as best seen in FIG. 4, the bottom flange 54 has first and second sections 54a and 54b. The first section 54a of the bottom flange extends inwardly from and in a direction perpendicular to the housing outer surface 50, and forms a stop against which the upper end of the support mounting section 14 of the support 12 engages when the support 12 is received in the adapter 38 as best seen in FIG. 3. The second section 54b of the flange 54 extends upwardly and perpendicular to the first section 54a in a direction substantially parallel to the housing outer surface 50.

Each flange 52 and 54 is configured to receive a corresponding section of a cover 60 (FIG. 2). Preferably, the cover 60 is substantially rectangular in shape, in elevation, is curved in plan view, and is constructed of a metal such as aluminum. As seen in FIG. 2, the cover 60 has a light transparent or translucent window 62 to allow ambient light to contact the light detection control unit 86 (described below). It is preferable that the window 62 is substantially elliptical in shape. Additionally, it is preferable that at least one aperture 64 (FIG. 2) is located on at least one of the flanges 52 and 54 or on the sides of the housing aperture 46 and extends into the housing outer surface 50. The aperture 64 receives at least one fastener 66 (e.g. a set screw) located on or extending through aperture 65 on the cover 60. Therefore, the cover 60 may be removably coupled to the housing 40. It should be understood that any suitable arrangement and construction may be used to removably fasten the cover 60 to the housing aperture 64.

As best seen in FIG. 4, a supporting rib 70 is disposed along the housing inner surface 48. The supporting rib 70 extends inwardly away from and in a direction substantially perpendicular to the housing inner surface 48. In the exemplary embodiment, the supporting rib 70 extends continuously around the housing inner surface 48 to support a light detection control unit socket 82. However, the supporting rib 70 may be disposed intermittingly. The supporting rib 70 should also have a vertically oriented wire opening 72. Wires 74 and 76 preferably feed through the opening 72 to allow the adapter to be pre-wired. For example, load side wires 74 come up a recess of the support 12 and extend through the supporting rib wire opening 72. Then, the load side wires 74 are connected to the light detection control unit 86. Line side wires 72 extend from the light detection control unit 86 to electrically connect to the ballast compartment 32 mounting plate. Thus, the adapter 38 is pre-wired for powering the electrical lamp 28.

As depicted in FIG. 4, the supporting rib 70 extends substantially coplanar to the first section 52a of the top flange 52. Therefore, structural integrity of the housing 40 is enhanced. However, it should be understood that alternative suitable arrangements and constructions may be used.

Turning to FIGS. 1 and 3, it is seen that at least one aperture 78 is also provided on at least one of the first and second ends 42 and 44 of the housing 40 to receive a suitable fastener 80 (e.g., a set screw). The at least one aperture 78 extends through the housing inner and outer surfaces 48 and 50. The at least one fastener 80 extends through the housing 40 and contacts one or both of the light fixture base 34 and the support mounting section 14 to lock the adapter 38 in a fixed position. In the exemplary embodiment, set screws are used as fasteners 80 and extend through two apertures 78 in the second end 44 of the housing 40 to couple the housing 40 to the support mounting section 14. Thus, the housing 40 is fixed in relation to the support mounting section 14 and the light fixture base 34.

Turning to FIG. 4, the supporting rib 70 described above, engages a light detection control unit socket 82. The socket 82 comprises a substantially annular disc having at least one aperture to receive a fastener 84. In the exemplary embodiment a threaded fastener 84 is utilized; however, alternative suitable arrangements and fasteners may used. The threaded fastener 84 connects to the light detection control unit 86. A surface of the disc engages a top surface of the supporting rib 70, thereby releasably coupling the light detection control unit 86 within the housing bore 51. Thus, the light detection control unit 86 is positioned proximate the housing aperture 46 to measure ambient light conditions.

The light detection control unit 86 is coupled to the socket 82. As shown in the exemplary embodiment, the light detection control unit 86 is recessed and located in the housing 40. The light detection control unit 86 is recessed in the housing 40 to eliminate any significant light from the lamp fixture 20 from falling on the light detection control unit 86, thereby preventing false readings. Preferably, the light detection control unit 86 is a conventional twist-type or button-type photocell. Photocells have been used for many years and therefore a detailed description of the conventional photocells functions and constructions is omitted for clarity and conciseness. Generally, as is well known in the art, a conventional photocell modifies the flow of an electric current in response to light waves. Consequently, a light fixture is controlled (i.e., turned on/off) based on ambient light conditions. Therefore, light that enters through the aperture 46 and window 62 controls the light detection control unit 86, which in turn controls the electrical lamp 28.

Lastly, a support 12 including a mounting section 14 is shown in FIGS. 1-3. Preferably the support 12 is a four inch outer diameter pole or a 5 inch diameter wall pole for post top mounting. It is preferable that the support mounting section 14 is substantially annular in shape, and advantageously substantially cylindrical. As best seen in FIG. 3, the support mounting section 14 is of suitable size for slidable and rotatable insertion into the second end 44 of the adapter housing 40. However, other suitable arrangements and constructions may be used, such as providing a support mounting section 14 sized to receive the second end 44 of the adapter therein. Support 12 is shown substantially vertically oriented and received in the ground; however, it can be oriented as desired and received in any desired structures.

### Assembly and Operation

Assembly and operation of the lamp assembly 10 according to an embodiment of the present invention will now be described with reference to FIG. 3. During assembly, the adapter 38 is releasably coupled between the light fixture base 20 and the support mounting section 14. Accordingly, an installer initially slides a second end 44 of the adapter housing 40 over the support mounting section 14 until the two parts can no longer axially slide due to relative contact therebetween and engagement of the support 12 with flange 54. Then, the installer slides the light fixture base 34 over the first end 42 of the adapter housing 40 until edge 35 of base 34 engages rim 43 of the adapter housing 40. Since the adapter 38 is independent of the support and the fixture, the adapter 38 is freely rotatable 360° to aim the light detection control unit 86 in a desired direction (usually north) away from any stray light that would inadvertently activate the light detection control unit 86. The light detection control unit 86 may be oriented by the installer or a user, and then releasably fixed in position by the use of fasteners 80 to engage the outer surface of the support mounting section 14. Although as seen in FIG. 3 the first end 42 is received within the light fixture base recess 36 and the second end 44 slides over the support mounting section 14, embodiments of the invention are not limited thereto. Additional suitable constructions and arrangements may be used.

In all events, once the lamp assembly 10 is constructed and mounted in the desired location, the adapter 38 is aimed in the desired direction and locked in place, and the electrical power is connected to the assembly 10, the lamp assembly is ready for use. Usually, the lamp 28 will not be activated until the light detection control unit 86 detects a predetermined level of ambient light. Conversely, when the ambient light level increases to a predetermined amount, the light detection control unit 86 will turn the lamp 28 off.

While the invention has been shown and described with reference to certain embodiments thereof, it will be understood by those skilled in the art that various changes in form and details may be made therein without departing from the spirit and scope of the invention as defined by the appended claims.

What is claimed is:

1. A lamp assembly, comprising:
a support including a mounting section;
a housing with a first end, a second end, and an aperture;
a light fixture having a base and adapted to receive an electrical lamp therein;
a locking mechanism arranged on said housing to lock said housing in a fixed position relative to said support mounting section and said light fixture;
a light detection control unit located on said housing, said light detection control unit adapted to control the electrical lamp based on ambient light conditions; and
said first end of said housing being engageable with said light fixture, and said second end of said housing being slidably engageable with said support mounting section so that said housing is rotatably positionable with respect to said support mounting section and said light fixture.

2. A lamp assembly according to claim 1, wherein
said first end of said housing is slidably engageable with said light fixture.

3. A lamp assembly according to claim 1, wherein
said base of said light fixture has a recess to receive said first end of said housing.

4. A lamp assembly according to claim 1, wherein
said support mounting section is positionable within said second end of said housing.

5. A lamp assembly according to claim 1, wherein
said housing second end comprises a substantially cylindrical recess, and
said support mounting section is substantially cylindrical.

6. A lamp assembly according to claim 1, wherein
said locking mechanism comprises at least one aperture to receive at least one fastener.

7. A lamp assembly according to claim 1, wherein
said housing has a removable cover having a window located thereon.

8. A lamp assembly according to claim 1, wherein
said light detection control unit is recessed within said housing.

9. A lamp assembly according to claim 1, wherein
said light detection control unit comprises a photocell.

10. A lamp assembly, comprising:
a support including a mounting section;
a housing with a first end, a second end, and an aperture;
a light fixture having a base and adapted to receive an electrical lamp therein;
a light detection control unit located on said housing, said light detection control unit adapted to measure ambient light conditions through said aperture to control the electrical lamp; and
said first end of said housing having a slidably engageable outer support surface to mate with said light fixture, and said second end having a slidably engageable recess to mate with said support mounting section so that said housing is rotatably positionable with respect to said support mounting section and said light fixture.

11. A lamp assembly according to claim 10, wherein
a locking mechanism is arranged on said housing, said locking mechanism has at least one aperture for receiving at least one fastener to lock said housing in a fixed position relative to said support mounting section and said light fixture.

12. A lamp assembly according to claim 10, wherein
said light detection control unit is recessed.

13. A lamp assembly according to claim 10, wherein
said housing has a removable cover located over at least part of said aperture, said cover having a window located thereon.

14. A lamp assembly according to claim 10, wherein
said base has at least one aperture to receive at least one fastener.

15. An adapter for a lamp assembly having a light fixture adapted to receive an electrical lamp therein and being mounted to a support with a mounting section, comprising:
a housing having a first end, a second end, and an aperture;
a locking mechanism arranged on said housing to lock said housing in a fixed position relative to said support mounting section and said light fixture;
a light detection control unit provided on said housing and adapted to measure ambient light conditions through said aperture to control said electrical lamp; and
said first end of said housing having an outer support surface slidably engageable with said light fixture, and said second end slidably enageable with said support mounting section so that said housing is rotatably positionable with respect to said support mounting section and said light fixture.

16. An adapter according to claim 15, wherein
said first end is slidably received within said light fixture, and said second end slidably receives said support mounting section.

17. An adapter according to claim 15, wherein
said first end slidably receives said light fixture, and said second end is slidably received within said support mounting section.

18. An adapter according to claim 15, wherein
said locking mechanism comprises at least one aperture to receive at least one fastener.

19. A adapter according to claim 15, wherein
said housing has a removable cover on which a window is disposed, said removable cover is mounted to said housing by at least one fastener.

20. A adapter according to claim 15, wherein
said light detection control unit is recessed within said housing.
